(19) United States
(12) Patent Application Publication
(10) Pub. No.: US 2002/0034642 A1
(43) Pub. Date: Mar. 21, 2002

(54) Optical member and manufacturing method thereof

(76) Inventors: Takashi Takahashi, Tokyo (JP); Toshiki Okumura, Tokyo (JP)

Correspondence Address: Richard L. Schwaab, FOLEY & LARDNER, Washington Harbour, 3000 K Street, N.W., Suite 500, Washington, DC, 20007-5109, US

(21) Appl. No.: 09/946,176

(22) Filed: Sep. 5, 2001

(30) Foreign Application Priority Data
Sep. 5, 2000 (JP) 2000-268995
Sep. 20, 2000 (JP) 2000-285406
Aug. 20, 2001 (JP) 2001-249162

(51) Int. Cl. B32B 17/06

(52) U.S. Cl. 428/426

(57) ABSTRACT

In a method for manufacturing an optical member used for UV region, a fluorine-based organic compound (for example, fluorinated oil) is filled between a plurality of optical members. The fluorine-based organic compound is provided between two lenses constituting the optical members. The periphery of the optical members is sealed with a sealant.

### BACKGROUND OF THE INVENTION

1. Field of the Invention

This invention relates to an optical member used for UV region (for example, an optical member used in a transmission optical system such as laminated lens, prism or the like) and a manufacturing method thereof.

2. Prior Art

Conventionally, inspection of a wafer or the like has been performed in a UV wavelength band of 200 nm-400 nm in a semiconductor device and other precise measuring devices, and a quartz (SiO₂) lens or fluorite (CaF₂) lens has been used for color convergence correction (achromatism) in such a semiconductor device and the like.

In the formation of a composite optical system by mutually sticking a plurality of (two) optical members (lenses), for example, an adhesive consisting of organic silcone resin of SILPOT 184 made by DOW CORNING or the like was filled in the clearance of the optical members (lenses) to adhesively bond the optical members (lenses) as shown in Japanese Patent Laid-Open No. 4-97927.

The adhesion of the optical members was also performed by use of a hydrolysate of silicone alcoholate such as ethylene silicate Si₅O₄(OC₂H₅)₁₂ or the like as shown in Japanese Patent Laid-Open No. 62-297247 or an inorganic salt of fluoride such as sodium fluoride, lithium fluoride, magnesium fluoride or the like as shown in Japanese Patent Laid-Open No. 1-75579.

When such an optical member is used particularly in a deep UV wavelength band of 200 nm-300 nm, however, ultraviolet ray is absorbed by the optical member in its transmission, causing the problem of the deterioration of characteristic of the optical member.

### SUMMARY OF THE INVENTION

This invention thus has an object to provide an optical member capable of reducing ultraviolet ray absorption to prevent the deterioration and a manufacturing method thereof.

According to this invention, the material to be filled in the optical member used for UV region is improved. As the optimum material, a fluorine-based organic compound is adapted.

For example, the method for manufacturing an optical member used for UV region is improved. The fluorine-based organic compound is filled between a plurality of optical members. A preferable example of the fluorine-based organic compound is fluorinated oil (fluorinated grease).

Further, the optical member used for UV region is improved. The fluorine-based organic compound is provided between the optical members. The fluorine-based organic compound is preferably fluorinated oil (fluorinated grease).

Further, the periphery of the optical members is preferably sealed with a sealant after the fluorine-based organic compound is filled in the clearance of the optical members.

### BRIEF DESCRIPTION OF THE DRAWINGS

This invention will be described in reference to the accompanying drawing wherein:

FIG. 1 is a schematic sectional view showing an optical member according to one preferred embodiment of this invention.

### DETAILED DESCRIPTION OF THE PREFERRED EMBODIMENTS

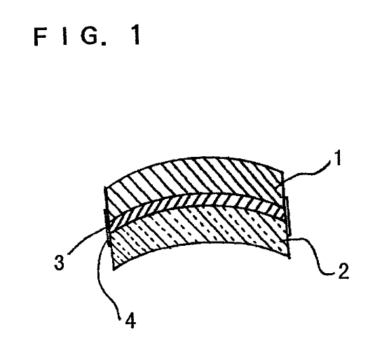

FIG. 1 shows one example of an optical member manufactured according to a manufacturing method of this invention.

In the example of FIG. 1, the optical member is formed of two lenses 1 and 2.

The lens is formed of fluorite (CaF₂) with a diameter of about 20 mm, and the lens 2 is formed of synthetic quartz (SiO₂) with a diameter of about 20 mm. A clearance entirely having a uniform thickness is preferably provided between the lenses 1 and 2. Fluorinated grease 3 that is one preferred example of the fluorine-based organic compound is filled in the clearance.

The dimension of the clearance is set to 10 μ2 m−20 μm.

The surface precision of the fluorite (CaF₂) lens 1 and the synthetic quartz (SiO₂) lens 2 is set to about 1/20 λ wherein λ represents a reference wavelength, and it is set to a transmitted UV wavelength of 200 nm-300 nm, for example, 248 nm. Also, 100-200 nm, for example, 193 nm, is possible by means of laser power.

The fluorinated grease 3 is resistant to an excimer laser such as KrF laser described later.

As the fluorinated grease 3, various ones can be used. The use of the following fluorinated greases is particularly preferred, but this invention is never limited by them.

EXAMPLE 1

Fluorinated grease made by DAIKIN INDUSTRIES Co., Ltd. (Tradename: DEMUNAM SERIES)

Formula 1

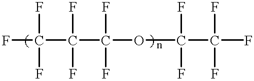

EXAMPLE 2

Fluorinated grease made by DU PONT

Formula 2

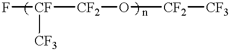

EXAMPLE 3

Fluorinated grease made by AUSIMONT SPA (Tradename: FOMBLINY)

Formula 3

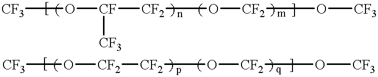

In the example of FIG. 1, the fluorinated grease made by DAIKIN INDUSTRIES Co., Ltd. is used.

The total thickness of the fluorite (CaF₂) lens 1, the fluorinated grease 3 and the synthetic quartz (SiO₂) lens 2 is set to about 5 mm in the state where the fluorinated grease 3 is filled between the lenses 1 and 2, although it is exaggeratedly shown in FIG. 1.

The whole periphery of the fluorite (CaF₂) lens 1 and the synthetic quartz (SiO₂) lens 2 may be sealed with a sealant 4 after the fluorinated grease 3 is filled between the lenses 1 and 2 as shown in FIG. 1. As the sealant 4, a one having an adhesive such as epoxy resin adhesive, acrylate resin adhesive, polyester resin adhesive, UV-hardenable adhesive, visible-hardenable adhesive or the like provided on a film or plastic can be used. In this case, the fluorite (CaF₂) lens 1 can be firmly bonded to the synthetic quartz (SiO₂) lens to surely prevent the leak of the fluorinated grease 3 from the periphery of the clearance between the lenses 1 and 2.

As the fluorine-based organic compound other than these fluorinated oils, AFLOUD (Tradename, made by ASAHI GLASS Co., Ltd.) and other perfluorocarbons (PFC, made by 3M, made by DU PONT) used as organic solvents can be used for the manufacture of the optical member used for UV region. Also, hydrofluoro carbon (HFC), hydrofluoro ether (HFE) or the like can be used.

<Experiment >

An optical member consisting of two lenses 1 and 2 was manufactured as shown in FIG. 1. An excimer laser such as KrF laser of deep UV 248 nm or the like was emitted to the optical member from a general direction at an output of 3 W/cm². The optical thickness of the fluorinated grease 3 was 10 μm, and the change of transmittance was hardly observed for the fluorinated grease 3.

<Comparative Experiment>

An optical member having the same shape and dimension (for example, the same diameter, thickness, and clearance between lenses 1 and 2) as the optical member used in the above experiment was manufactured by performing the adhesion of the fluorite (CaF₂) lens to the synthetic quartz (SiO₂) lens by use of an adhesive consisting of organic silicone resin of SILPOT 184 made by DOW CORNING instead of the filling of the fluorinated grease 3 to the clearance between the lenses 1 and 2. An excimer laser such as KrF laser of deep UV region 248 nm was emitted to the comparative experimental optical member for 148 hours at an output of 3 W/cm² in the same manner as the above experiment. Consequently, the layer formed by the adhesive consisting of organic silicone resin of SILPOT 184 made by DOW CORNING was peeled as burnt by the laser beam of the excimer laser, and deteriorated.

According to this invention, since the fluorine-based organic compound with less UV absorption (the preferable example is fluorinated oil) is used, the LIV absorption is significantly reduced, compared with the optical member using the conventional adhesive, and the deterioration can be remarkably prevented. Also, the deterioration of the optical member due to adhesion distortion can be prevented.

What is claimed is:

1. A method for manufacturing an optical member for use in UV region, which comprises filling a fluorine-based organic compound between a plurality of optical members.

2. A method for manufacturing an optical member according to claim 1 wherein the fluorine-based compound is fluorinated oil.

3. An optical member for use in UV region, which comprises a plurality of optical members and a fluorine-based organic compound provided between the optical members.

4. An optical member according to claim 3 wherein the fluorine-based organic compound is fluorinated oil.
